(19) United States
(12) Patent Application Publication
(10) Pub. No.: US 2006/0218034 A1
(43) Pub. Date: Sep. 28, 2006

(54) System and method for monitoring and recording research activity

(76) Inventor: Laird R. Kelly, Upper Grandview, NY (US)

Correspondence Address: DOCKET ADMINISTRATOR;LOWENSTEIN SANDLER PC, 65 LIVINGSTON AVENUE, ROSELAND, NJ, 07068, US

(21) Appl. No.: 11/089,390

(22) Filed: Mar. 23, 2005

(51) Int. Cl. G06F 11/34

(52) U.S. Cl. 705/11

(57) ABSTRACT

A research recording system is implemented via a toolbar on a Web browser. The system monitors and selectively records a user's research activity. Specifically, the system creates a record file that includes a recording of the user's research activity. The user's research activity may include access and interaction with one or more available resources, regardless of the location of the resource. Additionally, the system allows the user to submit note entries related to the research activity into the record file. The record file may be used to generate a report that is transmitted to a credit-granting institution for obtaining professional credit.

### BACKGROUND OF THE INVENTION

1. Field of the Invention

The present invention relates generally to a method and a system for monitoring and recording a user's research experience. More specifically, the present invention relates to a computer-based system that allows a user to record his or her research activity and personal notes in order to facilitate future research, document activity for record-keeping or billing purposes, and/or earn professional credit in educational courses or continuing education credit programs.

2. Related Art

The Internet offers a vast amount of resources for conducting a variety of forms of research. The Internet has greatly facilitated access to information and resources, providing professionals with a powerful and extensive array of resources for research. Using a conventional Web browser, a professional may search through collections of resources to locate information related to a particular issue or topic. Similarly, professionals may use a conventional search engine to locate educational courses, podcasts (educational audio programs delivered by subscription to an MP3-type player), and/or other online educational programs.

For this reason, many professionals, such as doctors and lawyers, utilize the Internet to conduct work-related research. As such, the Internet is a valuable “learning” tool that enables a professional to explore a large number of resources to educate himself or herself on a particular topic or subject matter. This type of learning is generally referred to as “self-directed” learning, because it is not bound by traditional parameters or directions typically provided by an educational class or course.

Professionals practicing in certain fields, such as law and medicine, are required to earn continuing-education credits in order to maintain his or her professional standing and, in some cases, professional licensure. Generally, an individual may earn professional credit by participating in certain educational programs, classes, symposia, and the like, offered by accredited continuing-education institutions. Traditionally, professionals attended a live lecture in order to earn continuing education credit. Now, “distance learning” based on enduring materials, known in the art as educational coursework that is not a live lecture, has gained prominence as an effective and convenient educational vehicle. Credit has also been offered via enduring materials including participation in educational programs delivered via the Internet, such as online courses, podcasts, CD-ROM's or other computer-based programs.

Due to the emergence of the Internet as a significant learning tool, professional credit institutions, such as the American Medical Association and the American Academy of Family Physicians, have recognized that the identification of a question relating to professional practice and the systematic research of possible answers to the question through self-directed research is a valid and credit-worthy form of learning. As such, many institutions are offering continuing-education credit for this type of professionally related research activity.

In order to substantively evaluate self-directed research to determine whether it is appropriate to grant credit for a professional's self-directed research activity, a credit institution requires evidence, typically in the form of written documentation, of the research activity.

Some conventional Websites offer professionals the opportunity to keep track of their accredited activities, whether they are web-based or otherwise. Typically a professional accesses a Website and manually inputs data concerning his or her previously earned credit-bearing activities. These sites are primarily focused on aiding the professional in his or her record keeping for activities earned on their Website.

Other conventional Websites provide a mechanism wherein search activity conducted on that site is automatically logged, credit-accrual is tracked, and credit-grant certificates are printed and delivered to the professional. However, this site-dependent tracking captures only the research activity conducted on that particular site. Disadvantageously, the professional's research capabilities (i.e., the type, format, and functionality of the search tools provided by the site) are limited to those offered by the site. Further, these conventional sites impose restrictions on the resources offered to the user, thereby limiting the professional's research activity to only the resources accessible via that particular site. This places a severe limitation on the breadth of resources and information that may be researched by the professional.

In addition to the need to track research activity for use in obtaining professional credit, professionals may also seek a record of his or her searching activity for inclusion in a patient's or client's file or to provide support for billing.

Accordingly, there is a need for a method and a system that allows a professional to track and record research activity for the purposes of obtaining professional credit, or other professional purposes, regardless of the location of the resource used in the research.

### SUMMARY OF THE INVENTION

The present invention provides a method and a system for recording a user's research activity and behavior, regardless of the point of origination of the research and regardless of the location of a resource accessed. A research recording system according to the invention monitors and records the user's research of any resource, whether accessible via the Internet or a local connection (i.e., a resource located on the user's computer or accessible via a local network).

According to an embodiment of the present invention, the system creates a file, referred to as a “record file,” of the user's research activity and results. In addition, the system provides the user with a note entry form, wherein the user may selectively input a running narrative of notes or diary entries that include commentary related to the research activity. According to an aspect of the present invention, the record file associates each user-inputted note with the research activity to which the note relates.

The system includes a software module that monitors and records the user's research activity. In a preferred embodiment, the research recording software module is a plug-in or similar addition to a Web browser operating on the user's computer. Preferably, the user interfaces with the software module via a toolbar embedded on the user's Web browser. By clicking a button on the toolbar, the user may initiate a recording of his or her research activity. When a research session is initiated, the software program creates or opens a record file to which the research activity is recorded. The toolbar also provides the user with a data collection form soliciting information from the user related to the research activity.

According to a yet another embodiment of the present invention, the research recording system allows the user to designate specific research findings for recording and facilitates the input and recording of one or more notes related to the research activity. A note entry form allows the user to input his or her own comments as he or she progresses through the research experience or activity. This personal note-taking function enables the user to develop and save a running narrative about the resources searched, documents reviewed, and findings derived from the research activity.

The system records data related to one or more goals and/or results of the research activity. Optionally, the system records the amount of time the user is engaged in research activity, particularly for use by credit-granting or billing systems that are based on time measurement. Further, the system may track a search conducted by the user during the research experience or activity. Specifically, the system monitors and records the search terms used by a user during a search and some or all of the search results that derive from the search.

According to an embodiment of the invention, at least a portion of the contents of the record file is incorporated in a report. The report may be transmitted to one or more destinations, such as, for example, a credit-granting institution. Using the report, the accreditation institution may evaluate the research activity to determine if professional credit should be granted. Thus, the present invention allows for an easy way to maintain, monitor, track, and accrue continuing-education credit. Furthermore, the present invention provides a tool for a user to capture work-related research activity for the purposes of billing, record-keeping, and as a resource for future research.

The research recording system may use color and/or other visual means to indicate to the user that his or her research activity is being monitored and recorded.

### BRIEF DESCRIPTION OF THE DRAWINGS

The features and advantages of the present invention will be apparent from the description of the preferred embodiment(s) presented below considered in conjunction with the attached figures, of which:

FIG. 1 is an illustration of an exemplary research recording system, according to an embodiment of the present invention;

FIG. 2 is a schematic illustration of a process flow for research activity recording, according to an embodiment of the present invention;

FIG. 3A is an exemplary illustration of a toolbar prior to initiation of a record file, according to an embodiment of the present invention; and

FIG. 3B is an illustration of a toolbar following initiation of a record file, according to an embodiment of the present invention.

It is to be understood that these figures are for purposes of illustrating the concepts of the invention and may not be to scale.

### DETAILED DESCRIPTION OF THE INVENTION

The present invention relates to a method and a system for recording a user's research experience or activity. Specifically, the method and the system according to the invention monitor and record a user's access to and interaction with one or more resources of information, independent of both the location of the one or more resources and the user's point of origination of the research.

Using a research recording system according to the present invention, the user may initiate a research session wherein the user's activity is monitored and recorded. A user's “research activity” includes but is not limited to access and interaction with one or more resources for the purposes of general, scholarly, scientific, and/or professional investigation, inquiry, study, review, analysis, and/or search. One having ordinary skill in the art will appreciate that the research activity includes all information related to the research process and any results derived therefrom.

The term “resource” is intended to include any source of data or information, and includes, but is not limited, to a Website, a file, a database, a computer program, a citation, an article, a publication, a book, streaming media, a live broadcast, etc. The term “resource” is intended to include computer-accessible sources, whether accessible via a Web-based network, such as the Internet, or accessible via a local network (e.g., stored locally on a network or a hard drive).

Once recorded, the research activity may then be generated into a report, which may be used to, among other things, obtain credit from one or more professional accreditation institutions, document time and effort for billing purposes, or merely record the trail and results of a research project for future reference.

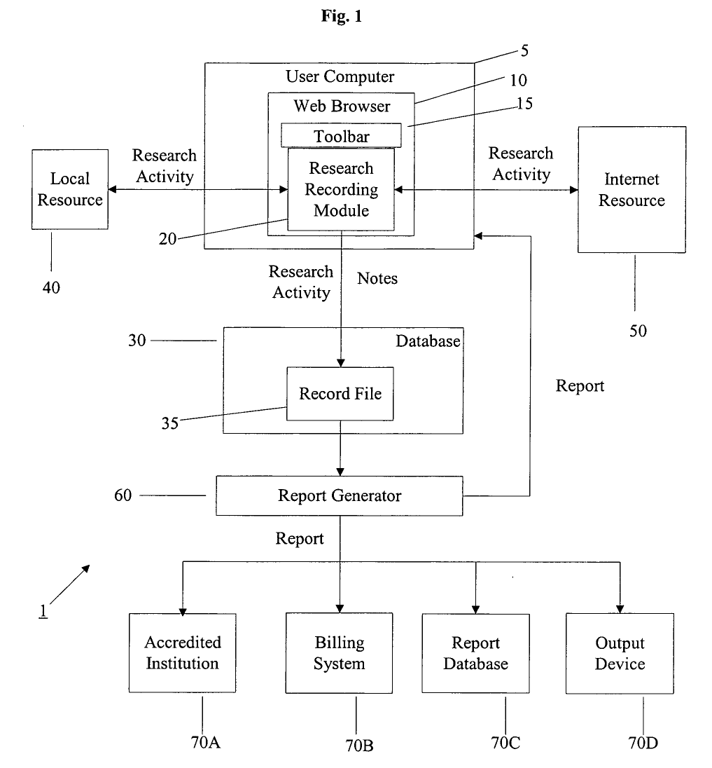

FIG. 1 provides a schematic depiction of a research recording system 1 according to an embodiment of the present invention. It is to be understood that the schematic representation of the system provided in FIG. 1 is exemplary in nature and alternative arrangements are within the scope of the invention.

According to a preferred embodiment, the research recording system 1 according to the present invention includes a computer, referred to as a User Computer 5, operated by a user taking part in research activity. The term “computer” is intended to include any data processing device, such as a desktop computer, a laptop computer, a mainframe computer, a personal digital assistant, a server, or any other device able to process data.

Referring to FIG. 1, the User Computer 5 includes a Web Browser 10 that provides a portal to one or more Web-based networks, such as for example the Internet. One having ordinary skill in the art will appreciate that any Web browser is suitable for use in the present invention, including but not limited to Microsoft® Internet Explorer, Netscape, Opera, WebTV®, FireFox, and Mozilla™.

The Web Browser 10 is communicatively connected to the Internet and provides the user with access to one or more resources available on the Internet, referred to as an “Internet Resource” 50. One having ordinary skill in the art will appreciate that the Internet Resource 50 may include any number of resources available on the Internet, and is not limited to a single resource. The term “communicatively connected” is intended to include any type of connection, whether wired or wireless, in which data may be communicated. The term “communicatively connected” is intended to include a connection between devices and/or programs within a single computer or between devices and/or programs on separate computers.

As shown in FIG. 1, a computer-executable software program, referred to as a “Research Recording Module” 20, is executed by and instructs the User Computer 5 to record a user's research activity and other information related to the research activity. One having ordinary skill in the art will appreciate that the Research Recording Module 20 may be configured to record the research activity in whole or in part. In a preferred embodiment, the user may select which portion of the research activity to record. For example, following the monitoring of research activity, the user may be presented with a list of the monitored research activity from which he or she may select which portion of the research activity to record.

Although the Research Recording Module 20 is described as being executed by the User Computer 5, one having ordinary skill in the art will appreciate that the Research Recording Module 20 may be executed by one or more computers communicatively connected to and accessible by the User Computer 5. Further, the invention is not limited by the location where the Research Recording Module 20 is stored. One having ordinary skill in the art will appreciate that the Research Recording Module 20 may include one or more computer programs that may be downloaded from a remote Website or installed onto the User Computer 5 using a known computer-storage medium, such as, for example, a compact disc, a DVD, wireless or infrared transmission or a floppy disc.

In a preferred embodiment the Research Recording Module 20 is communicatively connected to the Web Browser 10 and executed in conjunction with the Web Browser 10. One having ordinary skill in the art will appreciate that the Research Recording Module 20 may be a “plug-in” or similar companion to the Web Browser 10, such that it is executable via the Web Browser 10. The browser-based Research Recording Module 20 allows the user to research any resource, provided the user has access privileges for the resource, regardless of a location of the resource. Advantageously, the browser-based Research Recording Module 20 monitors and records the user's research of any resource, free from resource-limiting constraints set by a conventional site-based monitoring system.

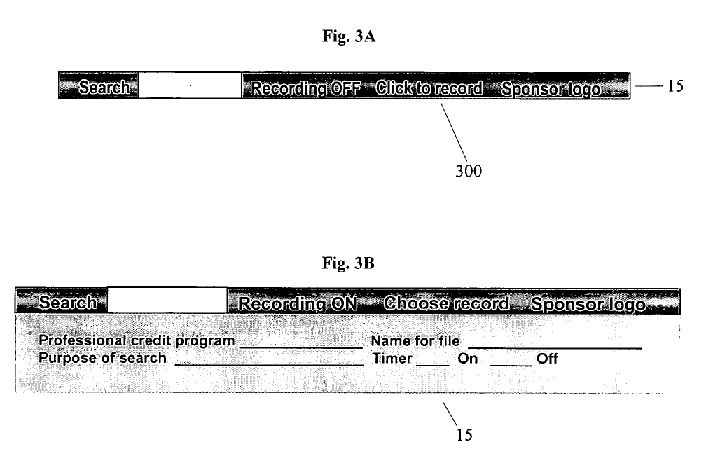

According to an embodiment of the present invention, the Research Recording Module 20 includes a toolbar or similar interface display, referred to as a “Toolbar” 15, which allows the user to access the Research Recording Module 20. Preferably, the Toolbar 15 is displayed in and accessible to the user via the Web Browser 15. Any known toolbar or display arrangement may be used, such that it allows the user to use and control the operation of the Research Recording Module 20. An exemplary Toolbar 15 depicting a display viewed by the user prior to initiation of a research session is shown in FIG. 3A.

According to an embodiment of the invention, the Toolbar 15 may include one or more buttons, inputtable fields, and/or information display areas. Each button includes a header or other identifying label, corresponding to the function of the button. The information display areas may indicate to the user information related to the Research Recording Module 20, such as for example, the mode of operation of the Research Recording Module 20 (i.e., whether the Research Recording Module 20 is in a “recording on ” or “recording off” mode). Optionally, information display areas may include company information such as a sponsor logo or other advertising-related banners or displays (e.g., a Web link).

The fields of the Toolbar 15 or the Research Recording Module 20, allow the user to provide certain information related to the research activity, such as, for example, a purpose of the research, one or more professional credit-granting programs to which a record of the research may be submitted, and a name for the record file. The Toolbar 15 may include a timer that tracks the time spent during a particular research session. Optionally, the user may turn the timer on or off using a timer “on/off” button on the Toolbar 15. The timer may include a known “time-out” mechanism by which the timer is halted in the event of a period of inactivity.

In addition to the Internet Resource 50, the Research Recording Module 20 also may be communicatively connected to one or more local resources, referred to as a “Local Resource” 40, as shown in FIG. 1. One having ordinary skill in the art will appreciate that the Local Resource 40 may include any number of local resources, and is not limited to a single local resource. The Local Resource 40 may include but is not limited to information or data that may not be accessible via the Internet, such as information or data stored locally on the User Computer 5 or accessible to the User Computer 5 via a local or regional wired or wireless network. One having ordinary skill in the art will appreciate that the Local Resource 40 may include but is not limited to a computer, a server, a database, a computer-executable file, or other computer-accessible memory. The term “computer-accessible memory” is intended to include any computer-accessible data storage device, whether volatile or nonvolatile, electronic, optical, or otherwise, including but not limited to, floppy disks, hard disks, CD-ROMs, DVDs, flash memories, ROMs, and RAMs.

One having ordinary skill in the art will appreciate that certain resources may be accessible via both the Internet and via a local connection, and may be considered either a Local Resource 40 or an Internet Resource 50 or both, for the purposes of the description of the present invention.

The user may utilize the Internet Resource 50, the Local Resource 40, or a combination thereof to conduct his or her research activity. As such, all research activity conducted by the user during a research session, regardless of whether it is conducted using the Internet Resource 50 or the Local Resource 40, is recorded by the Research Recording Module 20.

The Research Recording Module 20 is communicatively connected to a computer-accessible memory, referred to as a “Database” 30, for storage of the research activity and other information recorded by the Research Recording Module 20. Specifically, for each session of research activity, a file, referred to as a “Record File” 35, is created by the Research Recording Module 20 and stored in the Database 30. Accordingly, the Record File 35 is a record of the user's research activity, including the results of the research activity, either in whole or in part (i.e., including only the resources specifically designated by the user), comments on resources entered by the user, and other research activity-related information. Optionally, the user may categorize the Record File 35 in the Database 30 in a manner that will facilitate retrieval the Record File 35. For example, the user may categorize the Record File 35 in the Database 30 according to a research objective, by patient or client name, and/or by date. One having ordinary skill in the art will appreciate that the Database 30 may reside on the User Computer 5 and/or one or more other computers.

One having ordinary skill in the art will appreciate that during a research session, the Research Recording Module 20 may communicate with both the Local Resource 40 and the Internet Resource 50, and provide the user with a single Record File 35 including the integrated research activity related to the Internet Resource 50 and the Local Resource 40. Optionally, the Record File 35 may include only research activity related to the Internet Resource 50. Alternatively, the Record File 35 may include only research activity related to the Local Resource 40.

The Database 30 is communicatively connected to a software program executable by a computer configured to generate a report including information contained in the Record File 35, referred to as a “Report Generator” 60. The report integrates the research activity, research results, personal notes, user-designated category, and/or other information stored in the Record File 35. The Report Generator 60 is configured to retrieve or receive the Record File 35 from the Database 30, and creates one or more reports including all or a portion of the contents of the Record File 35. Advantageously, the Report Generator 60 may be configured to automatically generate a report upon completion of a Record File 35, generate one or more reports at set intervals of time (e.g., weekly or monthly reports), and/or generate a report at the request of the user.

According to an embodiment of the invention, the report generated by the Report Generator 60 may be customized. To create a customized report, the contents of the Record File 35 may be reviewed by the user or the Report Generator 60 to determine the information that is appropriate or desired for inclusion in the report. For example, if the user has notes including a patient's name, the patient's name may be deleted from the report by the Report Generator 60 to preserve the patient's confidentiality.

The Report Generator 60 is communicatively connected to one or more accreditation institutions, collectively referred to as an “Accredited Institution” 70A. Preferably, for a given Record File 35, the Report Generator 60 generates and transmits a report to the Accredited Institution 70A for review and evaluation by the Accredited Institution 70A to determine if credit should be granted for the research activity conducted by the user. In a preferred embodiment, the report includes the information related to the research activity necessary for the Accredited Institution 70A to conduct their review and evaluation. Advantageously, the report may be tailored or customized to suit each of the Accredited Institution's 70A standards, such that the report received by each of the Accredited Institution 70A is in an appropriate form and format and includes the appropriate information for each of the Accredited Institution 70A to base a credit-grant evaluation.

Furthermore, at the time the Record File 35 is created, the user may identify the Accredited Institution 70A to which he or she would like to report his or her research activity for the purposes of obtaining professional credit. In this scenario, the Record File 35 includes a tag or other identifying marker that includes information relating to the identified Accredited Institution 70A. Upon receipt of the Record File 35, the Report Generator 60 reviews the tag and automatically generates and transmits a report to the Accredited Institution 70A identified by the user. One having ordinary skill in the art will appreciate that a company or other organization, that may or may not be an Accredited Institution 70A, may serve as an aggregator of one or more of the Record Files 35 to collect, process, and transmit the Record Files 35 to the Accredited Institution 70A in quantity.

The report generated by the Report Generator 60 may serve a variety of additional purposes. Accordingly, the Report Generator 60 may be communicatively connected to other systems including a Billing System 70B, a Report Database 70C, and/or an Output Device 70D.

According to an embodiment of the invention, the Report Generator 60 generates and transmit one or more reports to the Billing System 70B, wherein the report provides support for billing for the research activity conducted by the user. The Record File 35 may include accounting information related to one or more clients, patients, or files. In a preferred embodiment, the accounting information is provided by the user during the research session, for example, via a data collection form, as discussed in more detail below. The accounting information is associated with the research activity, including the time spent in a designated research project, and the report including the accounting information is transmitted to, and in some cases, integrated with, the Billing System 70B to provide documentation for billing records.

Optionally, the Report Generator 60 may transmit the report to the Report Database 70C, a computer-accessible memory. According to an embodiment of the invention, the Report Database 70C may be accessed by a remote computer accessible by a professional organization or research organization. By accessing and reviewing the reports, these organizations may monitor the educational needs or informational interests of the users. Additionally, the Research Recording Module 25 may access the Report Database 70C to retrieve reports for display to the user to facilitate future research or to serve as reference materials. One having ordinary skill in the art will appreciate that the Report Database 70C may be stored on the User Computer 5 or other computer communicatively connected to the Research Recording Module 25 and the Report Generator 60.

Additionally, the Report Generator 60 may transmit the report to an Output Device 70D, such as, for example, a printer, a recordable medium (e.g., a compact disc or a floppy disc), a PDA, a tablet PC, a text-capable cell phone, or other portable digital device.

One having ordinary skill in the art will appreciate that the Research Recording Module 20, the Report Generator 60, and the Database 30 may be located within a single computer (such as the User Computer 5) or on separate computers communicatively connected together. Although represented schematically in FIG. 1 as separate elements, one having ordinary skill in the art will appreciate that the Research Recording Module 20 and the Report Generator 60 may be a single element, i.e., a single software program configured to perform the functions of the Research Recording Module 20 and the Report Generator 60.

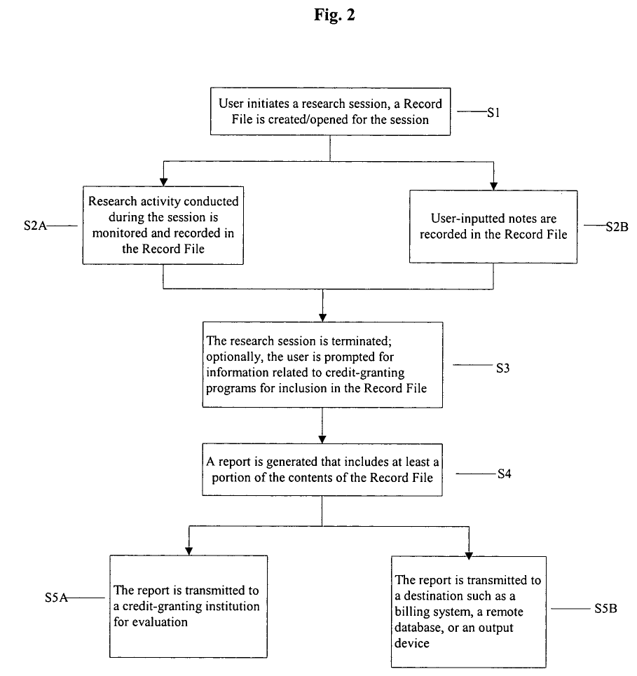

FIG. 2 illustrates an exemplary process flow of a research-activity recording method according to an embodiment of the invention. It is to be understood that the schematic representation provided in FIG. 2 is exemplary in nature and alternative arrangements are within the scope of the invention.

In step S1, the user interacts with the Research Recording Module 20 via the User Computer 5. In a preferred embodiment, the user interfaces with the Research Recording Module 20 using the Toolbar 15 presented in the Web Browser 10 of the User Computer 5. In order to begin recording his or her research activity, the user initiates a research session. To initiate a research session, (i.e., turn the recording function of the Research Recording Module 20 “on”), the user clicks an appropriate button on the Toolbar 15. For example, the user may click on a button labeled “Click to Record” 300, as shown in an exemplary Toolbar 15 in FIG. 3A. According to an embodiment of the invention, the Toolbar 15 may provide the user with a visual indicator of the mode of operation of the Research Recording Module 20. For example, the Toolbar 15 may open a new window for a “recorded search” that is separate and visually distinct form the user's “non-recording” Web Browser 10 window.

In a preferred embodiment, the Toolbar 15 and/or at least a portion of an interface window of the Research Recording Module 20 changes color to indicate to the user that the user's activity is currently being monitored and recorded. Preferably, the Toolbar 15 turns from a passive color (such as gray) when in a non-recording mode to a more visually stimulating color (such as red) when in a recording mode. Color indication of the mode of the Research Recording Module 20 advantageously alerts the user as to when recording is in progress to avoid the unintentional recording of any activity the user does not wish to record.

Once the research session has been initiated, the Research Recording Module 20 creates a new Record File 35. Alternatively, the Research Recording Module 20 may open an existing Record File 35. According to an embodiment of the present invention, the Toolbar 15 may provide a drop-down menu or open a separate window providing the user with a list of existing Record Files 35 from which to select for storing the research activity. Optionally, the Toolbar 15 may provide the user with a “browse” function wherein he or she may search existing files. According to another option, the Toolbar 15 may provide a search field wherein the user may input one or more search terms to identify and locate a desired existing Record File 35. Advantageously, opening an existing record and adding to it permits research to take place over multiple research sessions and/or originate from multiple computers.

To create the Record File 35, the Research Recording Module 20 provides the user with a data collection form that includes one or more fields to solicit information from the user about his or her research activity. The information solicited via the data collection form may include but is not limited to a name for the Record File 35, a purpose for the research, and/or one or more professional accreditation programs to which a report may be sent (discussed in further detail in relation to step S4). Upon completion of the data collection form and creation (or opening) of the Record File 35, the Research Recording Module 20 initiates recording of the user's research activity. An exemplary data collection form presented via the Toolbar 15 is shown in FIG. 3B.

Optionally, the user may select a level of monitoring and/or recording that is appropriate for a given research session. According to one embodiment of the present invention, prior to initiating a research session, the user may instruct the Research Recording Module 20 to monitor and record only the research activity that has a duration longer than a pre-determined amount of time. For example, the user may complete one or more fields of the data collection form that instruct the Research Recording Module 20 to record only for those resources accessed for longer than a period of ten minutes.

According to an embodiment of the present invention, the user may select which portion of his or her research activity to record. For example, the Research Recording Module 20 may record a portion of the research activity selected by the user. According to another example, the Research Recording Module 20 may record a portion of the research activity related to resources that are included on the user's pre-determined list of “favorite” resources (i.e., commonly accessed Websites).

According to an embodiment of the present invention, the Research Recording Module 20 may prompt the user, such as with a pop-up window, with a list of the resources accessed during the research session and ask the user to indicate which of the resources should be included in the Record File 35.

According to an embodiment of the present invention, the level of recording may be controlled such that only those resources that meet special criteria of informational quality are recorded. One having ordinary skill in the art will appreciate that credit-granting institutions, or other professional organization, may create their own collection of one or more resources that the institution or other organization recognizes as “pre-approved.” Optionally, the Research Recording Module 20 may provide a user with a list of pre-approved resources recognized by a credit institution from which the user is seeking credit. The user may elect to record only his or her research activity related to resources included on the credit institution's (or other professional organization's) pre-approved list. Optionally, the research activity conducted using the pre-approved resources is automatically credited by the credit institution.

According to an embodiment of the present invention, either before or after the monitoring of the research activity, the user may be prompted to select from a number of pre-approved lists created by one or more credit institutions or professional organizations, and instruct the Research Recording Module 20 to record only the research activity related to the resources included on the pre-approved list. For example, the user may elect to record his or her research activity conducted using the resources set forth in a collection of Websites approved by the American Academy of Family Physicians for the research of “Evidence-based Medicine.” According to an embodiment of the present invention, the Research Recording Module 20 may automatically, or at a user's election, cross reference a list of resources recorded during the session with a list of pre-approved resources provided by an Accredited Institution 70A or other content authority, and include in the Record File 35 only those resources that have a match.

According to still another embodiment of the present invention, the Research Recording Module 20 may allow the user to control how much, if any, information related to a resource is included in the Record File 35. For example, the user may elect to include only a specified portion of a resource in the Record File 35.

In step S2A, the research activity conducted by the user is automatically recorded by the Research Recording Module 20 to the Record File 35. The Research Recording Module 20 is programmed to record the research activity conducted using both an Internet Resource 50 and a Local Resource 40. The information related to the research activity that is stored in the Record File 35 may include but is not limited to any descriptive or identifying information related to the resource or data accessed via the resource, a URL of an Internet Resource 50, location identifying information related to a Local Resource 40, a title and/or other identifying information of a document or file that the user accesses during his or her research, or information related to a search conducted by the user during the research session (e.g., a name and location of the search engine and one or more search terms used).

One having ordinary skill in the art will appreciate that the user may access any type or format of file during his or her research activity, including but not limited to an application file, a document, an online course, an audio-visual presentation, a podcast, a reference article, an audio file, a video file, a text file, an image, etc. Further, it will be appreciated by one having ordinary skill in the art that any information related to the research activity may be recorded and stored in the Record File 35 and may be selected by the user according to his or her personal preferences. Optionally, the user may assign a distinctive name to a resource accessed during his or her research activity to facilitate retrieval of information provided by that resource from the Record File 35.

According to an embodiment of the invention, the research activity is recorded in the Record File 35 in chronological order. A time stamp indicating the date and time the user accessed the Internet Resource 50 or Local Resource 40 is generated and stored in the Record File 35. For example, the Record File 35 may have a listing of Website addresses listed in chronological order based on the time the user entered the Website, a sub-list of documents reviewed or selected for recording, etc., as shown in the exemplary Record File 35 depicted in the table below.

In step S2B, any narrative or personal notes provided by the user are recorded by the Research Recording Module 20. According to an embodiment of the invention, the Research Recording Module 20 provides the user with a note entry form in which the user may input his or her personal notes or narrative related to the research activity. The user may use the notes to build his or her own comments regarding the research activity into the record. The note entry form provided by the Research Recording Module 20 may be structured to include specific fields prompting the user for information, or may allow for an “open-ended” or narrative entry by the user.

According to an embodiment of the invention, the notes are dynamically associated with the research activity in the Research Record File 35. One manner in which the user's notes may be linked to the related research activity is by coordinating a time stamp assigned to a note entry and matching that time with the corresponding research activity. For example, a user may access an Internet Resource 50 having a URL address of “www.newjerseylawjournal.com/recentpublications/casesummaries/districtcourt” at 8:42 AM EST. While reviewing a summary of a recent New Jersey District Court opinion relating to a contract matter, the user may create a note at 8:46 AM EST reading “review Mr. Brown's contract with Company ABC to determine if the contract included any express warranties.” The user may then access another Internet Resource 50 having a URL address of “www.lexis.com” at 9:02 AM EST. Due to the chronology of events, the note entered at 8:46 AM EST will be associated with the research activity entered at 8:42 AM EST.

One having ordinary skill in the art will appreciate that the contents of the Record File 35 may be arranged in any suitable fashion, such as for example, based on the amount of time spent at a given resource, an alphabetical listing of the resources accessed during the research session, or other like arrangement. Optionally, the data entry form may include a rating scale wherein the user assigns a priority rating to a resource so that the contents of the Record File 35 may be displayed in the priority order determined by the user.

In step S3, the user terminates the research session. In an embodiment of the invention, the user may terminate the session by clicking an appropriate button on the Toolbar 15 or the Research Recording Module 20. For example, the user may click on a “Record Complete” button to end his or her research session. The user may then be prompted with one or more fields soliciting the user's analysis regarding the recently completed research, particularly as it relates to obtaining professional credit. For example, a separate window may open that asks the user to answer a number of questions, such as: “What was the question being researched?”, “What primary resources were reviewed?” “Was a satisfactory answered obtained?”, and “Are the results of the research applicable in practice?”, for example. The user's analysis and other solicited information may be included in the Record File 35 and used for applying for professional credit. Similarly, other questions may be posed if the purpose of the Record File 35 is to facilitate billing or for general research purposes.

In step S4, a report including all or a portion of the contents of the Record File 35 (e.g., the research activity entries, research results, and the note entries) is generated by the Report Generator 60, as described above with respect to FIG. 1. Optionally, the generated report may be displayed to the user for his or her review. As a part of this review, the user may have the option to customize the report by choosing which research activity entries he or she would like included in the report.

In step S5A, the report may be transmitted to one or more credit-granting institutions for which the user seeks professional credit. As described above, the report may include all or a part of the contents of the Record File 35. The report may be used by the credit-granting institution to evaluate whether to grant credit for the user's research activity.

In step S5B, which is an optional step, the report is transmitted to one or more other destinations. The destinations may include but are not limited to a billing system, a report database, and/or an output device such as a printer, a PDA, a cell phone or other digital device.

### EXAMPLE

The following is an illustrative example of an implementation of the research recording system 1 of the present invention. In the example, a user, Dr. Jones, wishes to conduct research related to his patient Mrs. Mary Smith. During a recent appointment, Mrs. Smith complained of swelling in her joints and pain when moving her arm and leg. Dr. Jones suspects that she might have Reiter's Syndrome, a form of arthritis that is rarely found in women. Prior to embarking on a plan of therapy, Dr. Jones wants to know more about the incidence and treatment of Reiter's Syndrome in women.

As a medical professional, Dr. Jones must satisfy certain continuing education requirements to maintain his licensure as a doctor. As such, Dr. Jones wishes to record to his research activity for use in obtaining professional credit.

Dr. Jones, using his computer, the User Computer 5, opens a Web Browser application, Microsoft® Internet Explorer, to access the Internet for his research. Also launched with the Internet Explorer application is the Toolbar 15 of the Research Recording Module 25. An example of the Toolbar 15 as presented Dr. Jones prior to use is shown in FIG. 3A.

Dr. Jones clicks on a “Click to record” button on the Toolbar 15 to initiate his research session. The Toolbar 15 launches the Research Recording Module 20 that opens a data collection form to solicit information needed for creation of a Record File 35 to record his research and other information required for his research activity to earn credit. The data collection form includes fields soliciting information such as a name for the Record File 35, the name of the professional credit program to which the Record File 35 is to be sent for obtaining credit, the purpose of the research, and a timer “on/off” field. In the data collection form, Dr. Jones indicates that he would like to earn credit in the Physician's Recognition Award program of the American Medical Association (AMA).

Using at least some of the information supplied by Dr. Jones in the data collection form, the Research Recording Module 25 creates a Record File 35 for Dr. Jones' research session.

Dr. Jones then begins his research activity. During his session, Dr. Jones accesses the following resources: 1) www.pubmed.com (a Website administered by the National Institutes of Health); 2) www.rheumatology.org (a Website administered by the American College of Rheumatology); 3) www.merckmedicus.com; 4) an audio podcast detailing the experience of a female Reiter's patient provided at www.clinicalpodcasting.com; 5) www.google.com to conduct a search for news about women and Reiter's Syndrome; and 6) a word document including Mrs. Smith's medical history located on his local hard drive. In addition, while auditing the audio podcast, Dr. Jones enters a note into the note entry form of the Toolbar 15 reading “compare Mrs. Smith two most recent x-ray to determine whether the swelling has increased.” A summary of the research activity is provided in the exemplary Record File 35 shown in the table below: One having ordinary skill in the art will appreciate that the data in the table below is provided for illustrative purposes only and may not represent actual URL resource identifiers.

TABLE I
Record File
Record File Name: Research for patient Mary Smith (Reiter's Syndrome)

| Date and Time of entry | | Information accessed |
|---|---|---|
| (EST) | Resource Identifier | via Resource |
| 2/16/05 08:43:58 AM | www.pubmed.com/ | Article titled “The |
| | articles/reiters.pdf | Effects of Reiter's |
| | | Syndrome” |
| 2/16/05 09:18:14 AM | www.rheumatology. | Research data related |
| | org/publications/ | to a study of Reiter's |
| | classifications/ | Syndrome |
| | reiters.com | |
| 2/16/05 09:39:42 AM | www.merckmedicus. | Four medical articles |
| | com; | related to symptoms of |
| | | Reiter's Syndrome |
| 2/16/05 10:02:19 AM | www. | An audio podcast |
| | clinicalpodcasting.com | detailing the |
| | | experience of a female |
| | | Reiter's patient |
| 2/16/05 10:39:23 AM | Note entry | “compare Mrs. Smith |
| | | two most recent x-ray |
| | | to determine whether |
| | | the swelling has |
| | | increased.” |
| 2/16/05 10:59:04 AM | www.google.com | Six selected citations |
| | | found among the |
| | | results of a search |
| 2/16/05 11:08:30 AM | C:\Patientfiles\ | Word document |
| | Activecases\ | including Mary |
| | MarySmith.doc | Smith's medical |
| | | history |

Following completion of the above research activity, Dr. Jones clicks on a “Stop Recording” button on the Toolbar 15 to terminate the research session. Because Dr. Jones indicated in at the beginning of the session that he would be seeking credit for his research activity from the AMA, he is prompted to answer questions required by the AMA for evaluation purposes. Dr. Jones's responses are then added to the Record File 35 and the entire Record File 35 is stored in a Database 30.

Next, the Record Generator 60 retrieves the Record File 35 titled “Research for patient Mary Smith (Reiter's Syndrome)” and generates a report including the contents of the file. The report is then automatically transmitted to an Accredited Institution 70A, or its designee, to determine if the record meets the criteria for credit toward the Physicians Recognition Award of the AMA. The Accredited Institution 70A reviews the report, determines that Dr. Jones's self-directed research activity is credit-worthy, and grants Dr. Jones professional credit accordingly.

Although the present invention has been described in considerable detail with reference to certain preferred embodiments and version, other versions and embodiments are possible. Therefore, the scope of the present invention is not limited to the description of the versions and embodiments expressly disclosed herein. The references and disclosure provided in the ‘Background of the Invention’ section are not admitted to be prior art with respect to the disclosure provided in the present application.

What is claimed is:

1. A computer-implemented method for recording a user's research activity, the method comprising the steps of:
monitoring research activity conducted by a user, wherein one or more resources available to the user for the research activity includes any computer-accessible resource, and wherein the step of monitoring is performed regardless of a location of the one or more resources;
recording at least a portion of the research activity to a record file, wherein the portion of the research activity recorded is selected by the user;
generating a report including at least a portion of the record file; and
transmitting the report to one or more destinations.

2. The method of claim 1, further comprising the step of recording time spent conducting the research activity.

3. The method of claim 1, further comprising the step of recording, to the record file, one or more user-inputted notes.

4. The method of claim 3, further comprising the step of providing the user with a note entry form for submission of the one or more notes related to the research activity.

5. The method of claim 3, wherein the report includes at least a portion of the one or more notes.

6. The method of claim 1, further comprising the steps of:
prompting the user to provide an analysis or rating of the research activity; and
recording, to the record file, the user's analysis or rating.

7. The method of claim 1, wherein at least one of the one or more resources is an Internet resource.

8. The method of claim 1, wherein at least one of the one or more resources is accessible via a local network.

9. The method of claim 1, wherein the one or more resources includes at least one resource accessible via a local network and at least one Internet resource.

10. The method of claim 1, wherein the record file includes a listing of one or more resources accessed by the user.

11. The method of claim 1, wherein the record file is stored in a computer-accessible memory.

12. The method of claim 1, wherein the one or more destinations include a credit-granting institution.

13. The method of claim 12, wherein the report transmitted to the credit-granting institution is used for purposes of obtaining professional credit for the user's research activity.

14. The method of claim 1, wherein the one or more destinations include a billing system.

15. The method of claim 1, wherein the one or more destinations include a database that stores the report.

16. The method of claim 1, wherein the record file includes a chronological listing of the one or more resources accessed during the research activity.

17. The method of claim 1, wherein the report is automatically generated upon completion of the research activity.

18. The method of claim 1, wherein the research activity recorded in the record file includes activity performed during multiple research sessions.

19. The method of claim 1, further comprising the step of providing a toolbar to the user for controlling the monitoring, the recording, the generating, and the transmitting steps.

20. The method of claim 1, wherein the portion of the research activity recorded includes one or more resources pre-approved by a credit-granting institution or other professional organization.

21. A system for recording a user's research activity, the system comprising:
a research recording module communicatively connected to a user computer and one or more resources, wherein the research recording module is configured to:
monitor research activity conducted by a user, wherein one or more resources available to the user for the research activity includes any computer-accessible resource, and wherein the monitoring is performed regardless of a location of the one or more resources; and
record at least a portion of the research activity to a record file, wherein the portion of the research activity recorded is selected by the user;
a database communicatively connected to the research recording module, wherein the database is configured to store the record file; and
a report generator communicatively connected to the database, wherein the report generator is configured to:
generate one or more reports based at least on a portion of the record file; and
transmit the one or more reports to one or more destinations communicatively connected to the report generator.

22. The system of claim 21, wherein the research recording module is configured to record, to the record file, a time spent conducting the research activity.

23. The system of claim 21, wherein the research recording module is configured to record, to the record file, one or more user-inputted notes.

24. The system of claim 21, wherein the research recording module is configured to prompt the user to provide an analysis or rating of at least a portion of the research activity, and to record, to the record file, the user's analysis or rating.

25. The system of claim 21, wherein the research recording module is executable via a Web browser on the user computer.

26. The system of claim 21, wherein the research recording module includes a toolbar, and wherein the toolbar is configured to allow the user to interact with the research recording module.

27. The system of claim 26, wherein the toolbar is configured to display at least one of: one or more buttons, a data collection form, and a timer.

28. The system of claim 27, wherein at least one of the one or more buttons allows the user to start and stop recording of the research activity.

29. The system of claim 27, wherein the data collection form solicits information from the user related to the research activity.

30. The system of claim 29, wherein the information solicited by the data collection form includes a name of a credit-granting institution to which the user wishes to transmit the report.

31. The system of claim 21, wherein the one or more destinations include a credit-granting institution.

32. The system of claim 21, wherein the one or more destinations include a billing system.

33. The system of claim 21, wherein the one or more destinations include a database accessible by the user for facilitating further research.

34. The system of claim 21, wherein the one or more destinations includes a report database assessible by one or more professional organizations for reviewing at least a portion of the report.

35. The system of claim 21, wherein at least one of the one or more resources is an Internet resource.

36. The system of claim 21, wherein at least one of the one or more resources is a local resource communicatively connected to the user computer via a local connection.

37. A computer-readable storage medium storing computer code for implementing a method for recording a user's research activity, wherein the computer code comprises:
code for monitoring research activity conducted by a user, wherein one or more resources available to the user for the research activity includes any computer-accessible resource, and wherein the step of monitoring is performed regardless of a location of the resource;
code for recording at least a portion of the research activity to a record file, wherein the portion of the research activity recorded is selected by the user;
code for generating a report including at least a portion of the record file; and
code for transmitting the report to one or more destinations.
